(19) United States
(12) Patent Application Publication
(10) Pub. No.: US 2025/0322751 A1
(43) Pub. Date: Oct. 16, 2025

(54) ENTERING/LEAVING ASSIST SYSTEM

(71) Applicant: TOYOTA JIDOSHA KABUSHIKI KAISHA, Aichi-ken (JP)

(72) Inventor: Chenyang WANG, Toyota-shi (JP)

(21) Appl. No.: 19/172,652

(22) Filed: Apr. 8, 2025

(30) Foreign Application Priority Data
Apr. 16, 2024 (JP) 2024-066316

(51) Int. Cl. G08G 1/14; B60W 30/06

(52) U.S. Cl. CPC G08G 1/144; B60W 30/06; B60W 2556/40

(57) ABSTRACT

An entering/leaving assist system is provided with a vehicle capable of autonomous driving and a mobile terminal having a user interface and capable of communicating with the vehicle. The vehicle is configured to calculate a recommended parking space when entering or a recommended route to the user when leaving, based on at least a position of the mobile terminal, a position of the vehicle, and usage history information of a parking lot relating to a user of the vehicle, when receiving an entering/leaving request of the vehicle from the mobile terminal. The mobile terminal is configured to, upon receiving the recommended parking space or the recommended route from the vehicle, propose entering the recommended parking space or leaving using the recommended route via the user interface.

### FIELD

The present disclosure relates to an entering/leaving assist system.

### BACKGROUND

JP2019-109616A discloses a remote parking system for automatically moving a vehicle into and out of a parking space by remotely operating the vehicle from outside the vehicle.

### SUMMARY

In the case of using a system for automatically moving a vehicle into and out of a parking space, the user may find it troublesome if he has to designate a destination (parking space) of the vehicle and a path to the user each time the user uses the system.

The present disclosure has been made focusing on the above problem, and an object thereof is to improve convenience in using a system for automatically moving a vehicle into and out of a parking space.

To solve the above problem, an entering/leaving assist system according to one aspect of the present disclosure is provided with a vehicle capable of autonomous driving and a mobile terminal having a user interface and capable of communicating with the vehicle. The vehicle is configured to calculate a recommended parking space when entering or a recommended route to the user when leaving, based on at least a position of the mobile terminal, a position of the vehicle, and usage history information of a parking lot relating to a user of the vehicle, when receiving an entering/leaving request of the vehicle from the mobile terminal. The mobile terminal is configured to, upon receiving the recommended parking space or the recommended route from the vehicle, propose entering the recommended parking space or leaving using the recommended route via the user interface.

According to this aspect of the present disclosure, it is possible to improve the convenience of using a system for automatically moving a vehicle into and out of a parking space.

### BRIEF DESCRIPTION OF DRAWINGS

FIG. 1 is a schematic view of a system that assists in moving a vehicle into and out of a parking space according to an embodiment of the present disclosure.

FIG. 2 is a flow chart for explaining an entering processing that assists in moving a vehicle into a parking space according to an embodiment of the present disclosure.

FIG. 3 is a view showing one example of a screen displayed on a user terminal when the user terminal receives a proposal signal.

FIG. 4 is a flow chart for explaining a leaving processing that assists in moving a vehicle out of a parking space according to an embodiment of the present disclosure.

FIG. 5 is a view showing one example of a screen displayed on a user terminal when the user terminal receives a path proposal signal.

### DESCRIPTION OF EMBODIMENTS

Below, referring to the drawings, an embodiment of the present disclosure will be explained in detail. It should be noted that, in the following explanation, similar component elements will be assigned the same reference notations.

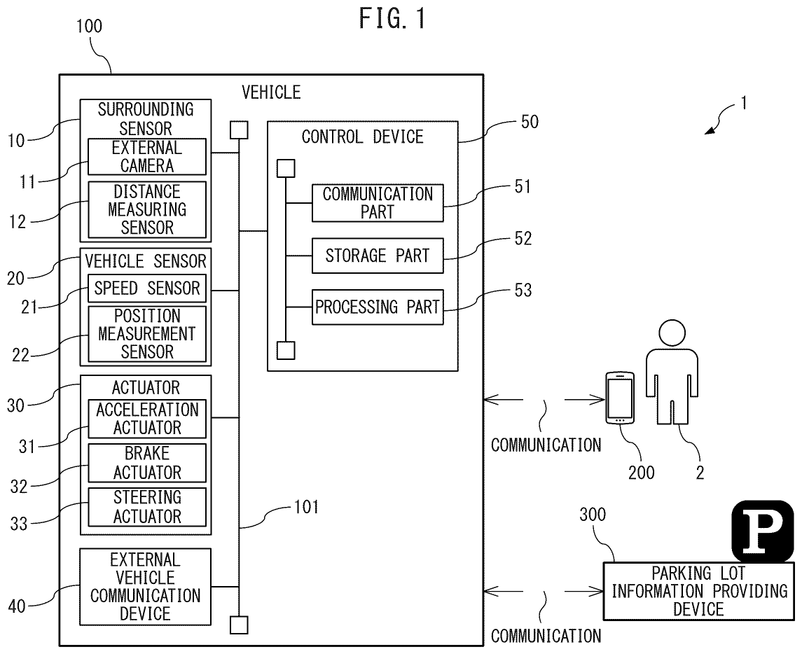

FIG. 1 is a schematic view of an entering/leaving assist system 1 that assists in moving a vehicle into and out of a parking space according to an embodiment of the present disclosure.

The entering/leaving assist system 1 is provided with a vehicle 100 and a terminal (hereinafter referred to as “user terminal”) 200 owned by a user 2 using the vehicle 100.

The vehicle 100 is provided with surrounding sensors 10, vehicle sensors 20, actuators 30, an external vehicle communication device 40, and a control device (driver assist control device) 50.

The surrounding sensors 1 are sensors for generating surrounding data showing the situation in the surroundings of the vehicle 100. In the present embodiment, as the surrounding sensors 1, one or more external cameras 11 for capturing the surroundings of the vehicle 100 and one or more distance measuring sensors 12 for measuring the distance to other vehicle, pedestrian, or other object present in the surroundings of the vehicle 100 are provided.

The external camera 11 captures the surroundings of the vehicle 100 by a predetermined frame rate (for example, 10 Hz to 40 Hz) and generates surrounding images in which the surroundings of the vehicle 100 are displayed. The external camera 11 sends the generated surrounding images as surrounding data to the control device 50 each time generating the surrounding images.

The distance measuring sensor 12 emits a plurality of laser beams, radio waves, ultrasonic waves, etc. different in emission angle to the distance measurement region of the surroundings of the vehicle 100 horizontal and in parallel and receives the reflected beams of the emitted laser beams or the reflected waves of the emitted radio waves or ultrasonic waves. Further, the distance measuring sensor 12 measures the distances to various objects present inside the distance measurement region based on the received reflected beams or reflected waves. The distance measuring sensor 12 transmits, as surrounding data, distance measuring data in which the distance to each object and the coordinate information of each object are associated with each other to the control device 50. As an example of a distance measuring sensor 12, for example, a lidar (light detection and ranging device) firing a laser and measuring distance based its reflected light, a millimeter wave radar sensor measuring distance based on the reflected wave, etc. may be mentioned.

The vehicle sensors 20 are sensors for generating vehicle data showing the situation of the vehicle 100. In the present embodiment, as the vehicle sensors 20, for example, a speed sensor 21 for generating speed data showing a running speed of the vehicle 100 and, for example, a position measurement sensor 22 for generating current position data showing the current position of the vehicle 100 such as the longitude and latitude etc. are provided. However, the vehicle sensors 20 are not limited to these sensors. The vehicle sensors 20 send the acquired data (for example, the speed data and current position data) as vehicle data to the control device 50.

The actuators 30 are devices used for controlling operations of the vehicle 100. In the present embodiment, as the actuators 30, acceleration actuators 31 (for example, at least one of the engine and motor) for controlling acceleration of the vehicle 100, brake actuators 32 (for example, a hydraulic actuator) for controlling braking of the vehicle 100, and steering actuators 33 (for example, a steering motor) for controlling steering of the vehicle 100 are provided.

The external vehicle communication device 40 is a vehicle-mounted terminal having a wireless communication function. The external vehicle communication device 40 is configured to be able to communicate with the user terminal 200 and a parking lot information providing device 300 installed at an entrance of a parking lot or the like. The parking lot information providing device 300 transmits real-time information of the parking lot to the vehicle 100 near the entrance of the parking lot. At this time, the parking lot information providing device 300 may be configured to detect the vehicle 100 entering the parking lot by infrared rays or the like and transmit real-time information of the parking lot to the detected vehicle 100.

The real-time information includes, for example, map information in the parking lot, an empty parking space in the parking lot, and feature information of the empty parking space (hereinafter, referred to as “parking space feature information”). The parking space feature information is information added to each parking space according to the feature of each parking space. As the parking space feature information, for example, information on equipment installed in the vicinity of a parking space, such as an entrance of a building or an elevator hall, may be mentioned. Further, as the parking space feature information, for example, information on equipment installed in the parking space itself, such as a charging station, may be mentioned. Further, as the parking space feature information, for example, information on a parking space number (parking section number) assigned to each parking space (parking section) of the parking lot may be mentioned. When the parking space is a dedicated parking space for an individual contract or a dedicated parking space for an elderly person or a physically disabled person, such information can also be added as parking space feature information.

The control device 50 is an ECU (electronic control unit) provided with a communication part 51, storage part 52, and processing part 53.

The communication part 51 has a communication interface circuit for connecting the control device 6 to the internal vehicle network 101. The communication part 51 supplies the various data received from the sensors 10 and 20, the external vehicle communication device 40, etc., to the processing part 53. Further, the communication part 51 outputs the various signals output from the processing part 63 to the actuators 30, external vehicle communication device 40, etc.

The storage part 52 has an HDD (hard disk drive), SSD (solid state drive), semiconductor memory, or other storage medium and stores various computer programs and data etc., used for processing at the processing part 53.

The storage part 52 stores, for example, map information. Further, the storage part 52 stores, for example, usage history information of a parking lot previously used by the vehicle 100 in the past. The usage history information of the parking lot includes, for example, parking lot information (for example, position information) for specifying the parking lot, position information of the parking space that has been parked, feature information of the parking space (which may be feature information that can be estimated from the position information), use time zone information of the parking lot (date, time, day of the week, and the like), map information in the parking lot created when the vehicle travels in the parking lot, and route information (route information between the entrance to the parking space and the exit) when the vehicle travels in the parking lot. In the present embodiment, the processing unit 53, and thus the control device 50, creates an image of a bird's-eye view of the vehicle 100 on the basis of the surrounding images captured by the external cameras 11 when the vehicle 100 is traveling in the parking lot, and stores the bird's-eye view image as map information in the storage unit 52.

The processing part 53 has one or more CPUs (central processing units) and their peripheral circuits and runs various computer programs stored in the storage part 52. The processing part 53 is for example a processor. The processor may further have other processing circuits such as a logical operation unit, numerical operation unit, or graphic processing unit.

The user terminal 200 is a mobile terminal having a user interface (for example, a touch panel display), a wireless communication function, and a position positioning function, such as a smartphone or a tablet computer owned by the user 2 using the vehicle 100. The user 2 can be automatically moved the vehicle 100 into and out of a parking space by operating the user terminal 200 from the outside of the vehicle 100 to activate an entering/leaving assistance application and performing a predetermined operation on the entering/leaving assistance application.

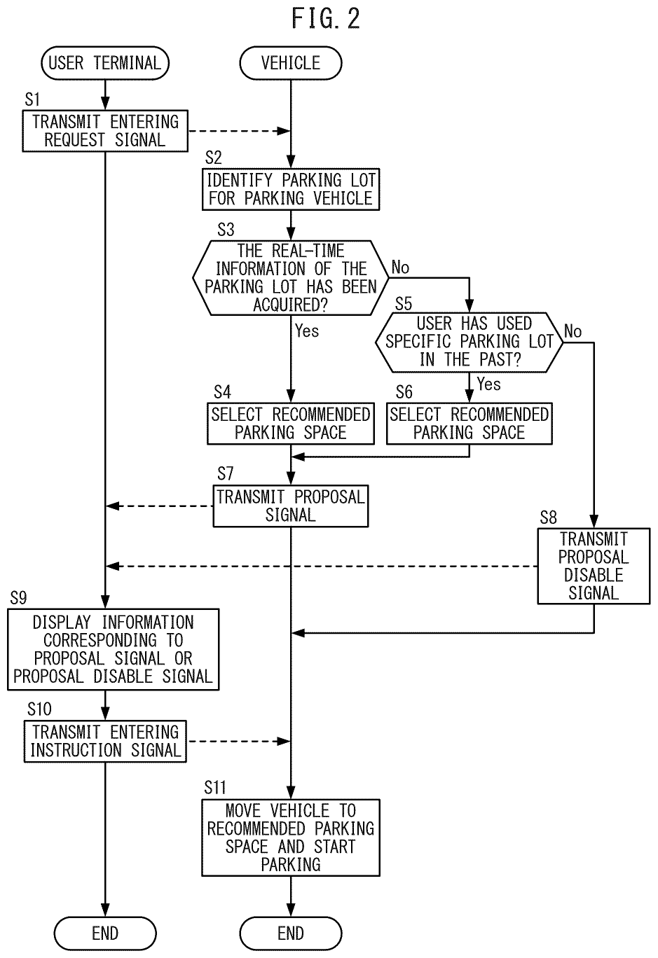

Hereinafter, an entering/leaving processing by the entering/leaving support system 1 will be described with reference to FIG. 2 to FIG. 5.

FIG. 2 is a flow chart for explaining an entering processing according to an embodiment of the present disclosure.

At Step S1, when the entering/leaving assistance application is activated, the user terminal 200 transmits an entering request signal or a leaving request signal to the vehicle 100 based on the current position of the user terminal 200 and the current position of the vehicle 100. Specifically, when the user 2 and the vehicle 100 are adjacent to each other, the entering request signal is transmitted, and when the user 2 and the vehicle 100 are not adjacent to each other (when they are separated from each other by a predetermined distance or more), the leaving request signal is transmitted. It should be noted that the user terminal 200 periodically acquires the current position data of the vehicle 100 by communicating with the vehicle 100 via the external vehicle communication device 40 while the vehicle 100 is traveling.

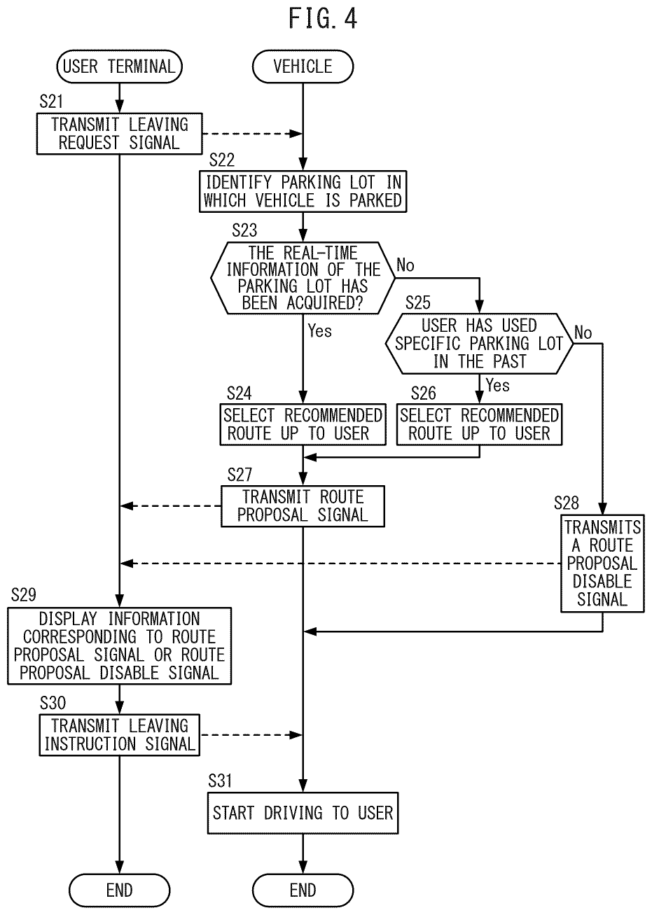

FIG. 2 is a flow chart for describing the entering processing, and therefore, a case where the entering request signal is transmitted in the step S1 will be described below. An example of a case where the leaving request signal is transmitted will be described later with reference to FIG. 4.

At Step S2, the control device 50 of the vehicle 100, upon receiving the entering request signal via the external vehicle communication device 40, identifies a parking lot for parking the vehicle 100 on the basis of the map information, the current position data acquired by the positioning sensor 22, and the surrounding image acquired by the external camera 11.

At Step S3, the control device 50 of the vehicle 100 determines whether or not the real-time information of the parking lot (specific parking lot) specified in the step S2 can be acquired from the parking lot information providing device 300 of the specific parking lot. If the real-time information of the specified parking lot has been acquired, the control device 50 proceeds to the processing of step S4. On the other hand, if the real-time information of the specified parking lot has not been acquired, the control device 50 proceeds to the processing of step S5.

At Step S4, the control device 50 of the vehicle 100 selects, as the recommended parking space, a parking space corresponding to the preference of the user 2 from among the empty parking spaces based on the real-time information of the specified parking lot and the usage history information of the parking lot of the user 2.

As described above, the real-time information includes an empty parking space in the parking lot and parking space feature information of the empty parking space, and the usage history information of the parking lot of the user 2 includes a use time period when the user 2 has used the parking lot in the past and parking space feature information of the parking space in which the vehicle 100 of the user 2 was parked. Therefore, the control device 50 first acquires the parking space feature information of each parking space parked in the past by the user 2 in the current time period based on the usage history information of the user 2.

Next, the control device 50 determines, based on the real-time information, whether there is an empty parking space to which the parking space feature information having the largest number of acquisitions is added from among the empty parking spaces in the parking lot, and, if there is an empty parking space to which the parking space feature information having the largest number of acquisitions is added, selects the empty parking space as the recommended parking space. Then, if there is no empty parking space to which the parking space feature information having the largest number of acquisitions is added, the control device 50 determines whether there is an empty parking space to which the parking space feature information having the largest number of acquisitions is added next, and repeats such processing until an empty parking space is found.

This is, as parking space feature information of each parking space in which the user 2 has parked in the past in the current time zone, for example, in the case where there is information such as “near the entrance of the building”, “near the entrance of the elevator hall”, and “there is a charging station”, that the parking space feature information such as “near the entrance of the elevator hall” is obtained the most, the user 2 has parked the most in the parking space in the past “near the entrance of the elevator hall”. This is because the parking space “near the entrance of the elevator hall” can be estimated as the preferred parking space for user 2. When the usage history information of the specific parking lot is present as the usage history information of the parking lot, only the usage history information of the specific parking lot may be used in this step.

At step S5, the control device 50 of the vehicle 100 determines whether the user 2 has used the specific parking lot in the past, i.e., whether there is usage history information of the specific parking lot. When the user 2 has used the specific parking lot in the past, i.e., there is the usage history information of the specific parking lot, the control device 50 proceeds to the processing of step S6. On the other hand, if the user has not used the specified parking lot in the past, the control device 50 proceeds to the processing of step S7.

At step S6, the control device 50 of the vehicle 100 selects the parking space according to the preference of the user 2 as the recommended parking space on the basis of the usage history information of the specified parking lot and the use history information of the parking lot of the user 2.

As described above, the usage history information of the parking lot includes the map information of the parking lot created when the parking lot is traveled in the past. Therefore, the control device 50 first acquires the parking space feature information of each parking space parked in the past by the user 2 in the current time period based on the usage history information of the user 2. Next, the control device 50 refers to the map information in the specific parking lot, and determines whether there is a parking space having the parking space feature information having the largest number of parking spaces in the parking space. If there is a parking space having the parking space feature information having the largest number of parking spaces in the parking space, the control device 50 selects the empty parking space as the recommended parking space. Then, if there is no parking space having the parking space feature information with the largest number of acquisitions, the control device 50 determines whether there is a parking space having the parking space feature information with the next largest number of acquisitions, and repeats such processing until the parking space is found.

In this case, it is not known at present whether the recommended parking space is an empty parking space, and if the parking space is not an empty parking space when the vehicle 100 arrives the recommended parking space, a search for a nearby empty parking space is performed.

At step S7, the control device 50 of the vehicle 100 transmits a proposal signal for proposing the recommended parking space to the user 2 to the user terminal 200.

At step S8, the control device 50 of the vehicle 100 transmits, to the user terminal 200, a proposal disable signal for notifying the user 2 that the proposal of the recommended parking space cannot be made because the location of the parking space in the parking lot or the like is unknown.

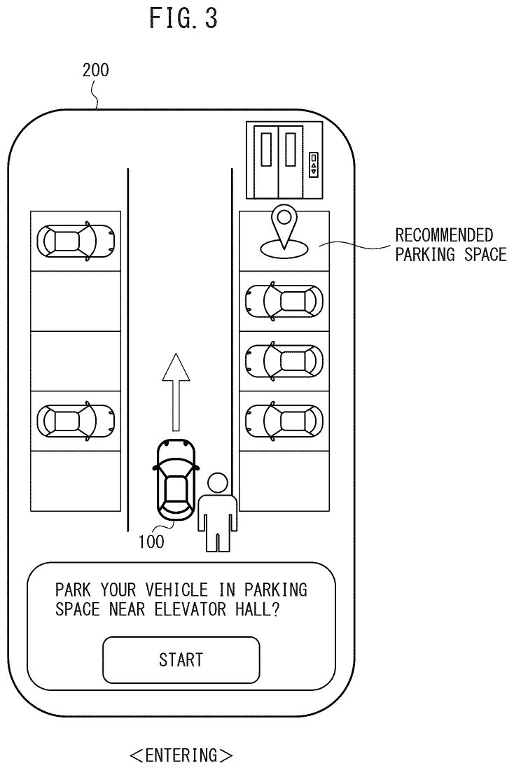

At step S9, upon receiving the proposal signal or the proposal disable signal, the user terminal 200 displays information corresponding to the received signal to the user 2 via the user interface. For example, when the user terminal 200 receives the proposal signal, as shown in FIG. 3, it displays a simple map in the parking lot, the current position of the vehicle 100, the recommended parking space, and information related to the feature information of the recommended parking space (in the example shown in FIG. 3, information related to the elevator hall is displayed to indicate that it is a parking space near the entrance of the elevator hall), and displays a start button (hereinafter referred to as a “first entering start button”) for confirming whether to start parking in the recommended parking space. Further, when, for example, receiving the proposal disable signal, the user terminal 200 displays a message indicating that the proposal of the recommended parking space cannot be made, and a start button (hereinafter, referred to as a “second entering start button”) for confirming whether to start parking in an empty parking space as soon as the empty parking space is found, to the user 2 via the user interface.

At step S10, when the first or second entering start button is pressed, the user terminal 200 transmits an entering instruction signal to the vehicle 100.

At step S11, upon receiving the entering instruction signal, the control device 50 of the vehicle 100 automatically performs the drive control of the vehicle 100 by controlling the actuator 30, when the first entering start button has been pressed, it moves the vehicle 100 to the recommended parking space and parks it. On the other hand, the control device 50, when the second entering start button has been pressed, it moves the vehicle 100 to the nearest empty parking space and parks it. The search for the nearest empty parking space can be performed based on, for example, the surrounding image captured by the external camera 11.

FIG. 4 is a flow chart for explaining a leaving processing that assists in moving a vehicle out of a parking space according to an embodiment of the present disclosure.

At step S21, the user terminal 200 transmits the leaving request signal to the vehicle 100.

At step S22, the control device 50 of the vehicle 100 identifies the parking lot in which the vehicle 100 is parked on the basis of the map information, the current position data acquired by the position measurement sensor 22, and the surrounding image acquired by the external camera 11 when receiving the leaving request signal via the external vehicle communication device 40.

At step S23, the control device 50 of the vehicle 100 determines whether or not the real-time information of the specific parking lot has been acquired from the parking lot information providing device 300 of the parking lot (the specific parking lot) specified in the step S22. If the real-time information of the specified parking lot has been acquired, the control device 50 proceeds to the processing of step S24. On the other hand, if the real-time information of the specific parking lot has not been acquired, the control device 50 proceeds to the processing of step S25.

At step S24, the control device 50 of the vehicle 100 selects a recommended route up to the user 2 that matches the preference of the user 2 on the basis of the real-time information of the specific parking lot and the usage history information (route information) of the specific parking lot. Specifically, the control device 50 grasps a usage route used by the user 2 in the past based on the usage history information (route information) of the specific parking lot of the user 2. Based on the real-time information of the specific parking lot, the control device 50 calculates the currently least busy route among all routes in the usage route, i.e., the route with the shortest arrival time to the user 2, and selects the route as the recommended route. When there is no usage history information (route information) of the specific parking lot, the control device 50 selects the route with the shortest arrival time to the user 2 as the recommended route.

At step S25, the control device 50 of the vehicle 100 determines whether the user 2 has used the specific parking lot in the past, i.e., whether there is usage history information of the specific parking lot. If the usage history information of the specific parking lot is found, the control device 50 proceeds to the processing of S26. On the other hand, if the user 2 has not used the specific parking lot in the past, the control device 50 proceeds to the processing of step S27.

At step S26, the control device 50 of the vehicle 100 selects a recommended route to the user 2 that matches the preference of the user 2 on the basis of the usage history information of the specific parking lot. Specifically, the control device 50 selects, as the recommended route, the usage route most frequently used among the usage routes used in the past by the user 2.

At step S27, the control device 50 of the vehicle 100 transmits a route proposal signal for proposing the recommended route to the user 2 to the user terminal 200.

At step S28, the control device 50 of the vehicle 100 transmits, to the user terminal 200, a route proposal disable signal for notifying the user 2 that the proposal of the recommended route cannot be made because the details in the parking lot are unknown.

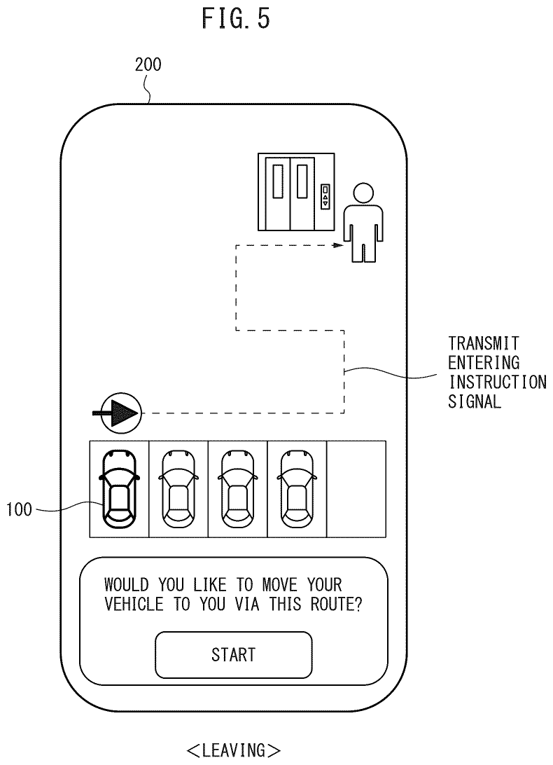

At step S29, upon receiving the route proposal signal or the route proposal disable signal, the user terminal 200 displays information corresponding to the received signal to the user 2 via the user interface. For example, when the route proposal signal is received, the user terminal 200 displays a simple map in the parking lot, the current position of the vehicle 100, the recommended route, and the current position of the user 2, as shown in FIG. 5. In addition, the user terminal 200 displays a start button (hereinafter referred to as a “first leaving start button”) for confirming whether the vehicle 100 is to be moved out of the parking space by traveling the recommended route. On the other hand, when, for example, receiving the route proposal disable signal, the user terminal 200 displays, to the user 2 via the user interface, a message indicating that the proposal of the recommended route cannot be made, and a start button (hereinafter referred to as a “second leaving start button”) for confirming whether the vehicle 100 is to be moved out of the parking space by letting the vehicle travel as it happens,

At step S30, when the first or second leaving start button is pressed, the user terminal 200 transmits a leaving instruction signal to the vehicle 100.

At step S31, upon receiving the leaving instruction signal, the control device 50 of the vehicle 100 controls the actuators 30 to automatically perform the travel control of the vehicle 100. When the first leaving start button is pressed, the control device 50 causes the vehicle 100 to travel to the user 2 by using the recommended route. When the second leaving start button is pressed, the control device 50 appropriately selects a route that can be traveled, and causes the vehicle 100 to travel to the user 2.

The entering/leaving assist system 1 according to the present embodiment explained above is provided with the vehicle 100 capable of autonomous driving and the user terminal 200 (mobile terminal) having the user interface and capable of communicating with the vehicle 100. The vehicle 100 is configured to calculate the recommended parking space when entering or the recommended route to the user when leaving, based on at least a position of the user terminal 200, a position of the vehicle 100, and usage history information of a parking lot relating to a user 2 of the vehicle 100, when receiving the entering/leaving request of the vehicle 100 from the user terminal 200. The user terminal 200 is configured to, upon receiving the recommended parking space or the recommended route from the vehicle, propose entering the recommended parking space or leaving using the recommended route via the user interface.

In this way, according to the present embodiment, it is possible to propose the recommended parking space when the entering request is received from user 2 via user terminal 200. Further, it is possible to propose the recommended route when the leaving request is received from user 2 via user terminal 200. In other words, when the vehicle 100 is automatically moved into a parking space, it is possible to eliminate the trouble of specifying a destination (parking space). When the vehicle 100 is automatically moved out of a parking space, it is possible to eliminate the trouble of specifying a route to user 2. Therefore, it is possible to improve the convenience of using the he entering/leaving assist system 1.

Further, according to the present embodiment, the vehicle 100 is configured to acquire real-time information including the map information in the parking lot and the information on the current empty parking space of the parking lot, and calculate the recommended parking space when entering or the recommended route when leaving in consideration of the real-time information.

In this way, by considering the real-time information of the parking lot, it is possible to accurately propose the recommended parking space or the recommended route suitable for the preference of the user 2.

Further, according to the present embodiment, the vehicle 100 is configured to receive the entering instruction to the recommended parking space or the leaving instruction using the recommended route from the user terminal 200, and perform entering to the recommended parking space or leaving using the recommended route by autonomous driving.

Above, embodiments of the present disclosure were explained, but the embodiments only show some of the applications of the present disclosure and are not meant to limit the technical scope of the present disclosure to the specific configurations of the embodiments.

For example, in the above embodiments, the computer programs run at the control device 50 may be provided in a form recorded at a computer readable portable recording medium such as a semiconductor memory, magnetic recording medium, or optical recording medium.

1. An entering/leaving assist system comprising:
a vehicle capable of autonomous driving; and
a mobile terminal having a user interface and capable of communicating with the vehicle, wherein
the vehicle is configured to calculate a recommended parking space when entering or a recommended route to the user when leaving, based on at least a position of the mobile terminal, a position of the vehicle, and usage history information of a parking lot relating to a user of the vehicle, when receiving an entering/leaving request of the vehicle from the mobile terminal, and
the mobile terminal is configured to, upon receiving the recommended parking space or the recommended route from the vehicle, propose entering the recommended parking space or leaving using the recommended route via the user interface.

2. The entering/leaving assist system according to claim 1, wherein,
the vehicle is configured to:
acquire real-time information including the map information in the parking lot and the information on the current empty parking space of the parking lot; and
calculate the recommended parking space when entering or the recommended route when leaving in consideration of the real-time information.

3. The entering/leaving assist system according to claim 1, wherein,
the vehicle is configured to:
receive an entering instruction to the recommended parking space or a leaving instruction using the recommended route from the mobile terminal; and
perform entering to the recommended parking space or leaving using the recommended route by autonomous driving.
